(19) United States
(12) Patent Application Publication
(10) Pub. No.: US 2007/0080302 A1
(43) Pub. Date: Apr. 12, 2007

(54) Faraday cup assembly and method of controlling the same

(76) Inventor: Sun-Ho Hwang, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/544,705

(22) Filed: Oct. 10, 2006

(30) Foreign Application Priority Data
Oct. 12, 2005 (KR) 2005-0096109

(51) Int. Cl. G01K 1/08

(52) U.S. Cl. 250/397

(57) ABSTRACT

A faraday cup assembly includes a frame attached to a sidewall of a vacuum chamber, a lead screw rotatably attached to the frame, a drive unit which rotates the lead screw, a carrier engaged with the lead screw and horizontally movable with a rotation of the lead screw, a faraday cup located in the vacuum chamber, a shaft extending through the frame and including a first end engaged with the faraday cup and a second end attached to the carrier a brake unit which selectively stops the rotation of the lead screw, and a main controller which controls at least one of the drive unit and the brake unit.

### BACKGROUND OF THE INVENTION

1. Field of the Invention

The present invention relates generally to a semiconductor device manufacturing apparatus and a method of controlling the same and, more particularly, to a faraday cup assembly including a brake unit for selectively braking the rotation of a lead screw that moves a faraday cup, and to a method of controlling the same.

A claim of priority is made to Korean Patent Application No. 2005-0096109, filed Oct. 12, 2005, in the Korean Intellectual Property Office, the entirety of which is incorporated by reference.

2. Description of the Related Art

Generally, a semiconductor device is manufactured by sequentially, selectively, and repeatedly subjecting a semiconductor wafer or substrate to unit processes. Examples of such unit processes include deposition, photolithography, etching, ion implantation, polishing, cleaning, and drying processes.

The ion implantation process is used to implant impurities into a wafer by directing ion impurities into selected surface regions of the wafer. Generally, the process is tailored to achieve a given impurity concentration and impurity depth within the wafer.

An ion implantation apparatus generally includes a faraday cup assembly which is utilized in an effort to achieve a desired impurity concentration and impurity depth within the wafer. A conventional faraday cup assembly will now be described with reference to the schematic views of FIGS. 1A and 1B. FIG. 1A shows a state before an ion implantation process is performed, and FIG. 1B shows a state during the ion implantation process.

Referring to FIG. 1A, the conventional faraday cup assembly includes a faraday cup 20 for measuring the dosage of an ion beam (not shown), a horizontal drive shaft 22 connected to faraday cup 20 through a sidewall 10 of a vacuum chamber, a lead screw 30 aligned in parallel with and spaced from the shaft 22, and a drive motor 38 for rotating lead screw 30.

The reaction chamber for performing the ion implantation process with respect to a wafer W in a high vacuum state is defined to the right side of the sidewall 10 illustrated in FIG. 1A. On the other hand, most of the components of the faraday cup assembly are placed under atmospheric pressure at the left side of the sidewall 10.

A sealing part 24 is formed between the shaft 22 and the sidewall 10. A carrier 28 is engaged with the lead screw 30 so as to traverse along the lead screw. 30 as the lead screw 30 is rotated. One end of the shaft 22 is fixed to a support plate 26 which is connected to the carrier 28. As such, the shaft 22 moves together with the carrier 28.

One end of the lead screw 30 is rotatably supported on a support member 12, while the other end is fixed to a first drive pulley 32. The drive pulley 32 is connected to a second drive pulley 36 by a belt 34. The second drive pulley is operatively coupled to the drive motor 38. In this manner, the rotational force of the drive motor 38 is transmitted to the lead screw 30.

The reaction chamber includes a platen 40 for supporting the wafer W, a tilt part 42 connected to a lower end of the platen 40 to rotate the platen 40, and a drive shaft 44 connected to a lower end of the tilt part 42 to raise and lower the platen 40 and the tilt part 42. The shaft 22 may move faraday cup 20 to check the uniformity of ion beams prior to the ion implantation process being performed.

After checking for the uniformity of ion beams, the drive shaft 44 is raised and the tilt part 42 is rotated to dispose the wafer W in a direction perpendicular to that of an ion beam to perform the ion implantation process as shown in FIG. 1B. At this time, the faraday cup 20 measures a dosage of the ion beam injected to the wafer W while being located at a position just adjacent to the wafer W.

While the prior art ion implantation apparatus and method may be used for ion implantation, it has several shortcomings. For example, under some circumstances, incorrect control signals may be applied to the drive motor 38. This may occur due to, for example, an error in a controller (not shown) or an interruption in the power supply to drive motor 38 during the ion implantation process. If incorrect control signals are applied to drive motor 38, the faraday cup assembly may be unable to control the position of the faraday cup 20.

In this case, the reaction chamber to the right of the sidewall 10 is placed under high vacuum while the space to the left of the sidewall 10 is placed under atmospheric pressure. Due to the resulting pressure difference, the faraday cup 20 may move to the right to collide with the wafer W and the platen 40 supporting the wafer W.

### SUMMARY OF THE INVENTION

One aspect of the disclosure includes a a faraday cup assembly. The faraday cup assembly may include a frame operatively fixed to a sidewall of a vacuum chamber. The assembly may also include a lead screw rotatably installed on the frame. The assembly may also include a drive unit which rotates the lead screw. In addition, the assembly may include a carrier operatively connected to the lead screw to move horizontally based on the rotation of the lead screw. Furthermore, the assembly may include a faraday cup disposed in the vacuum chamber. The assembly may also include a shaft installed through the frame, the shaft including a first end operatively connected to the faraday cup and a second end operatively connected to the carrier. The assembly may also include a brake unit which stops the rotation of the lead screw. The assembly may also include a main controller which controls at least one of the drive unit and the brake unit.

Another aspect of the disclosure includes a method of controlling a faraday cup assembly by braking a lead screw which moves a faraday cup of the assembly. The method may include aligning a faraday cup to a reference position spaced apart from a wafer to be disposed in a process position where an ion implantation process is performed. The method may also include detecting a position of the faraday cup using a faraday cup position detection unit. The method may also include selectively braking a lead screw by applying a brake or non-brake signal to a lead screw brake unit based on the position of the faraday cup.

### BRIEF DESCRIPTION OF THE DRAWINGS

The above and other features of the present invention will become readily apparent from the detailed description that follows, with reference to the accompanying drawings, in which:

FIGS. 1A and 1B are schematic views of a conventional faraday cup assembly;

FIG. 2 is an exploded perspective view representation of a faraday cup assembly according to an exemplary disclosed embodiment;

FIG. 3 is a side view representation of a faraday cup assembly installed at a sidewall of a vacuum chamber according to an exemplary disclosed embodiment;

FIGS. 4A and 4B are cross-sectional views of a brake unit included in a faraday cup assembly according to an exemplary disclosed embodiment;

FIGS. 5A and 5B are cross-sectional views of a brake unit included in a faraday cup assembly according to an alternative exemplary disclosed embodiment;

FIG. 6A is a side view of a faraday cup assembly when a wafer is in a standby position according to an exemplary disclosed embodiment;

FIG. 6B is a side view of a faraday cup assembly when a wafer is in a process position according to an exemplary disclosed embodiment; and

FIG. 7 is a flowchart illustrating the steps of an exemplary disclosed faraday cup assembly control method.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions may be exaggerated for clarity. Like reference numerals designate like elements throughout the drawings.

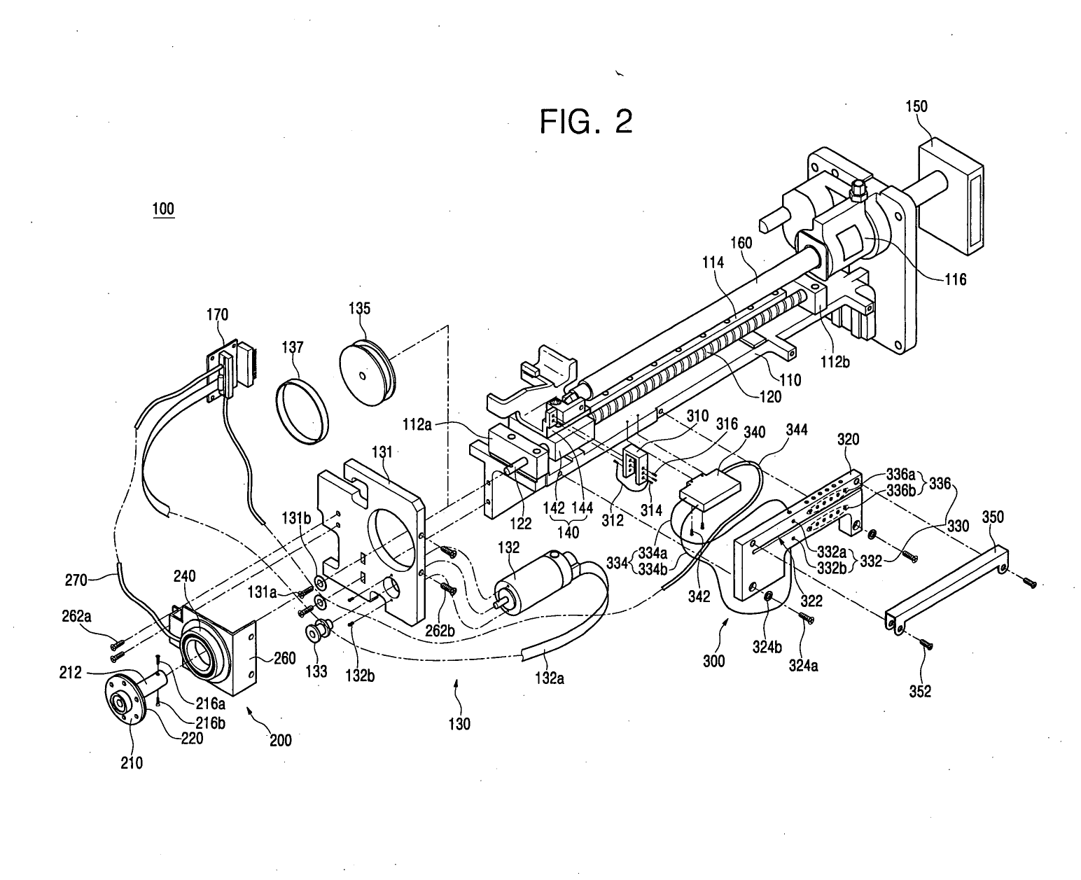

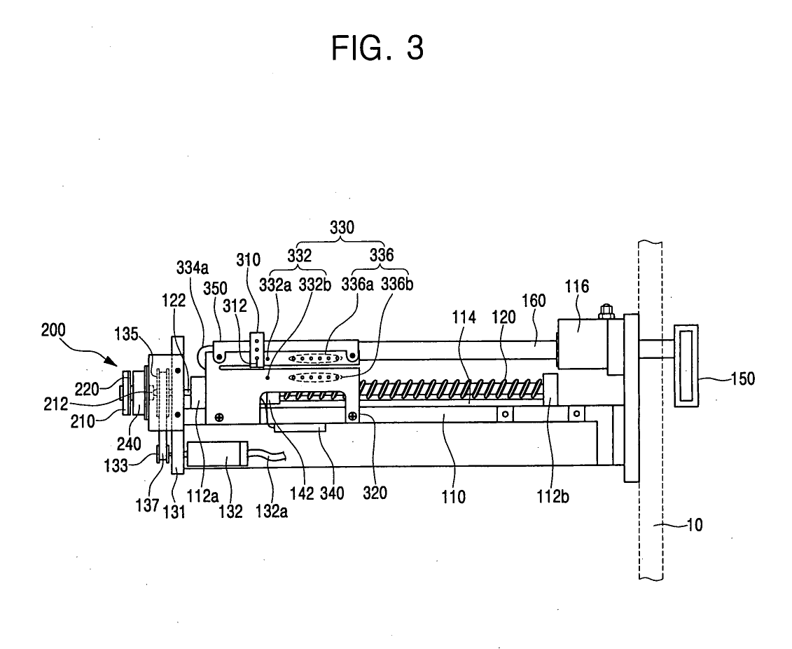

FIG. 2 is an exploded perspective view of a faraday cup assembly 100 and FIG. 3 is a side view of faraday cup assembly 100 installed at a sidewall of a vacuum chamber.

Referring to FIGS. 2 and 3, the faraday cup assembly 100 includes a frame 110, a lead screw 120, a drive unit 130, a carrier 140, a faraday cup 150, a shaft 160, a brake unit 200, and a main controller 170.

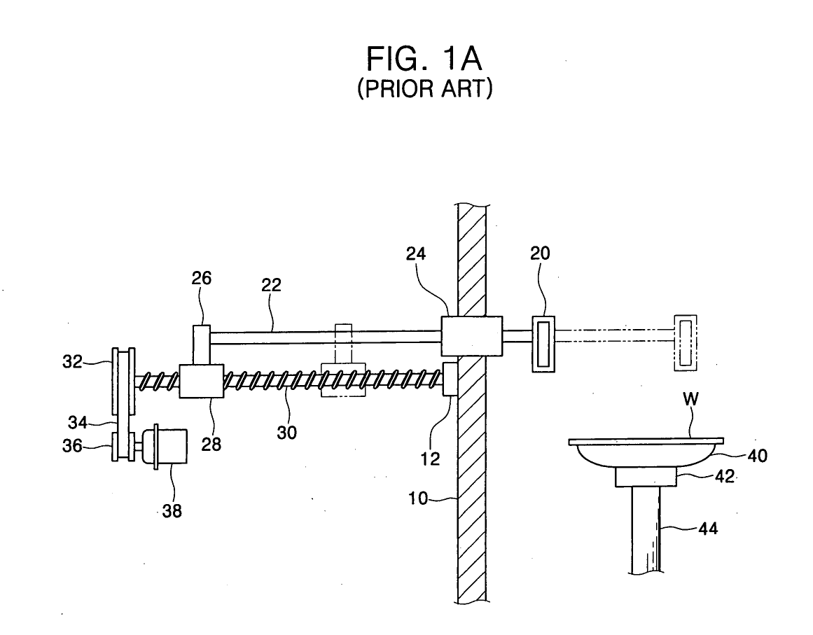

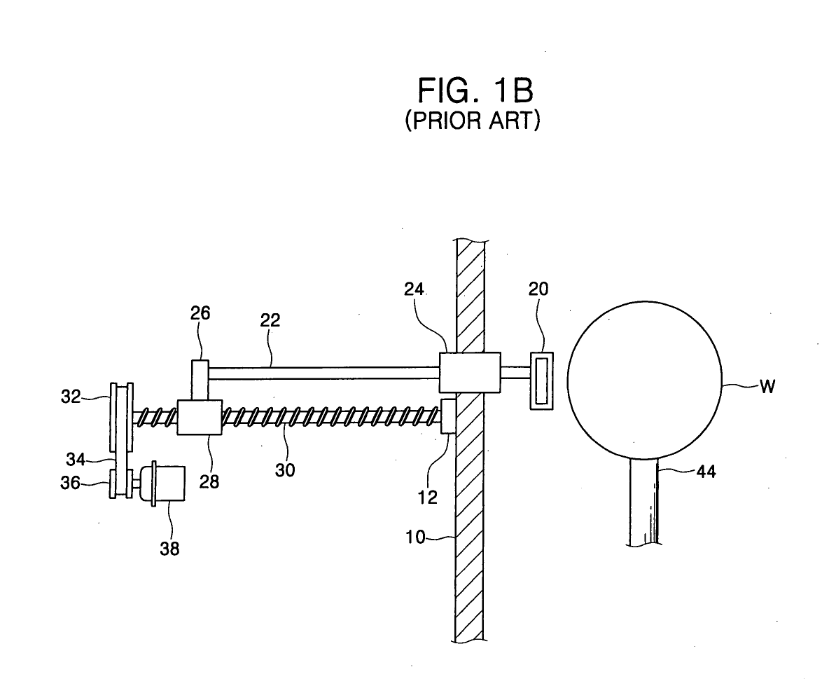

The frame 110 is fixed to the sidewall 10 of a vacuum chamber (see FIG. 1). In an exemplary embodiment, the frame 110 may be directly fixed to sidewall 10. Alternatively, the frame 110 may be coupled to sidewall 10 using a coupling mechanism, such as, for example, a mechanical coupler. In addition, any other mechanism may be used to operatively the fix frame 110 to the sidewall 10.

The lead screw 120 may be configured to connect to the frame 110. In an exemplary embodiment, the lead screw 120 may use the lead screw connection shaft 122 and supporting members 112a and 112b to connect to the frame 110. Specifically, the lead screw 120 may be provided with the lead screw connection shaft 122 which is formed at one end of the lead screw 122 and rotatably supported through the support member 112a fixed on the frame 110. The other end of the lead screw 120 may be rotatably inserted into the other support member 112b fixed on the frame 110. This configuration may allow the lead screw 120 to be rotatably installed on the frame 110 by a predetermined distance.

The carrier 140 is configured to move horizontally based on the rotation of the lead screw 120. In an exemplary embodiment, the carrier 140 may be installed on the lead screw 120. The carrier 140 may include a carrier body 142 which may have balls interposed therein and is threadedly engaged with the lead screw 120. The carrier 140 may also include a shaft fixing bracket 144 mounted on an upper surface of the carrier body 142. This configuration may be used to move the carrier 140 horizontally along an LM guide 114 connecting support members 112a and 112b when the lead screw 120 is rotated.

The drive unit 130 is configured to rotate the lead screw 120. In an exemplary embodiment, the drive unit 130 may include a drive unit bracket 131 fixed to one side of the frame 110. Drive unit 130 may also include a drive motor 132 mounted on the drive unit bracket 131 to provide a rotational force. In addition, the drive unit 130 may also include a drive pulley 133 fixedly connected to the drive motor 132, a driven pulley 135 fixedly connected to the lead screw connection shaft 122, and a belt 137 connecting the drive pulley 133 and the driven pulley 135. The belt 137 may be used to transmit the rotational force of the drive motor 132 to the lead screw 120.

The drive unit bracket 131 is operatively fixed to the frame 110. In an exemplary embodiment, a fixing screw 131 a and a washer 131b may be used to fix the drive unit bracket 131 to the frame 110. Alternatively, any other fastening technique may be used to fix the drive unit bracket 131 to the frame 110. Furthermore, the drive unit bracket 131 also operatively connects to the drive motor 132. In an exemplary embodiment, a fixing screw 132b may be used to connect the drive unit bracket 131 to the drive motor 132.

The drive motor 132 operatively connects to the main controller 170 to receive power and drive signals from the main controller 170. In an exemplary embodiment, a cable 132a may be used to connect the drive motor 132 to main controller 170.

The faraday cup 150 is disposed in the vacuum chamber (not shown). The faraday cup 150 may be used to perform a number of functions. In an exemplary embodiment, the faraday cup 150 may be used to check the uniformity of an ion beam before performing an ion implantation process. In addition, during the ion implantation process, the faraday cup 150 may be used to measure a dosage of the ion beam as a beam current in order to adjust the dosage and depth of ions implanted into a wafer. Furthermore, the faraday cup 150 may be used to perform other such functions related to the ion implantation process.

The movement of the faraday cup 150 may be controlled using various mechanisms. In an exemplary embodiment, a faraday cup adjusting shaft 160 may be used to control the movement of the faraday cup 150. The faraday cup 150 may be operatively fixed to the shaft 160 so that a movement of the shaft 160 may cause a movement of the faraday cup 150, thereby adjusting the position of the faraday cup 150.

The shaft 160 may be operatively fixed to the faraday cup 150 via the frame 110. Specifically, the shaft 160 may be installed through the frame 110, with one end of shaft 160 fixedly connected to the faraday cup 150 and the other end fixedly connected to the shaft fixing bracket 144. Therefore, the shaft 160 may move together with the carrier 140 depending on the rotation of the lead screw 120, thereby resulting in a change to the position of the faraday cup 150. In addition, a sealing part 116 may be formed at the part of the frame 110 through which the shaft 160 passes. The sealing part 116 may prevent leakage of the vacuum chamber and ensure smooth movement of the shaft 160.

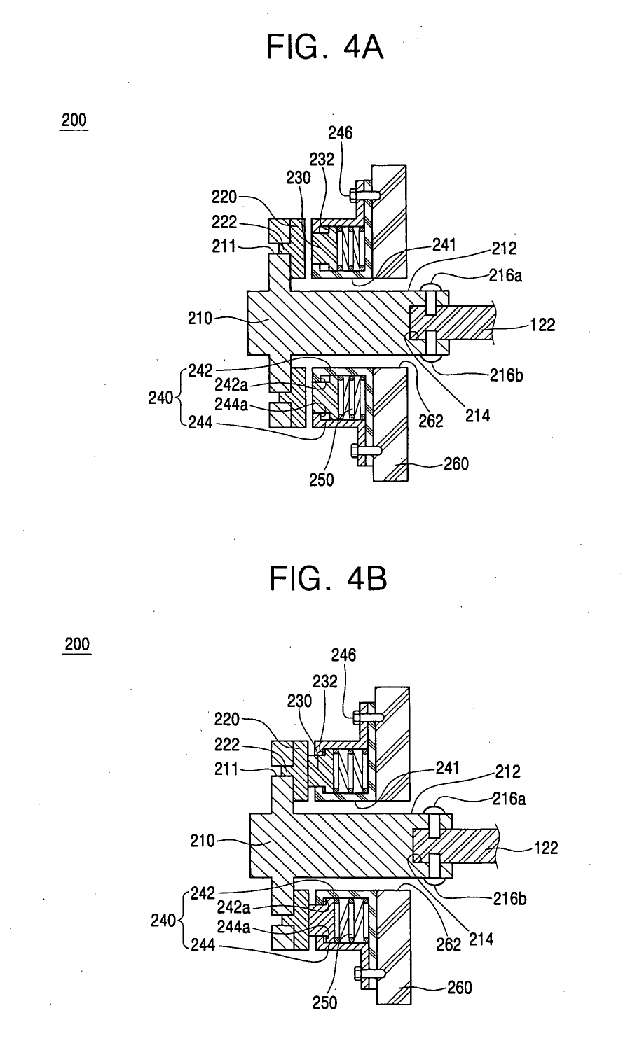

Hereinafter, an embodiment of a brake unit 200 for stopping rotation of the lead screw 120 will be described with reference to the accompanying drawings. FIGS. 4A and 4B are cross-sectional views of the brake unit 200 included in the faraday cup assembly 100 in accordance with an embodiment of the present invention. Specifically, FIG. 4A is a cross-sectional view of the brake unit 200 in a non-brake state, and FIG. 4B is a cross-sectional view of the brake unit 200 in a brake state.

Referring to FIGS. 2, 4A and 4B, the brake unit 200 includes a brake gear 210, fixing screws 216a and 216b, a first magnetic generator 220, a second magnetic generator 230, a brake housing 240, and a brake unit bracket 260. The brake gear 210 also includes a brake shaft 212.

The brake gear 210 may be operatively connected to lead screw 120. In an exemplary embodiment, the brake gear 210 may fixedly connect to the lead screw 120. Specifically, the lead screw connection shaft 122 may be inserted into the brake shaft 212 and may be fixed by the fixing screws 216a and 216b. The resulting connection between the brake gear 210 and the lead screw 120 may cause the brake gear 210 to rotate along with the lead screw 120.

The first magnetic generator 220 may be of various shapes. In an exemplary embodiment, the first magnetic generator 220 may be ring-shaped. Alternatively, the first magnetic generator 220 may be shaped differently such as a square, rectangle, etc. The first magnetic generator 220 may be mounted on the brake gear 210. Specifically, the first magnetic generator 220 may have a plurality of projections formed at one surface. The plurality of projections may be closely fitted into a plurality of grooves 211 formed at the brake gear 210, thereby securely mounting the first magnetic generator onto the brake gear 210.

The second magnetic generator 230 may be disposed adjacent to first magnetic generator 220 and movably housed in a brake housing 240. Furthermore, the second magnetic generator 230 may be configured to react with the first magnetic generator 220 to generate an attraction or repulsion force, thereby being in contact or non-contact with the first magnetic generator 220. In addition, similar to the first magnetic generator 220, the second magnetic generator 230 may also be ring-shaped with a predetermined thickness. Furthermore, the magnetic generator 230 may include thresholds 232 formed at inner and outer edges of its one end. In an exemplary embodiment, the first magnetic generator 220 may be a permanent magnet and the second magnetic generator 230 may be an electromagnet whose polarity changes depending on the direction of the current supplied.

The brake housing 240 may be configured to receive the second magnetic generator 230. In an exemplary embodiment, the brake housing 240 may have a cylindrical shape. The brake housing 240 may also include a through-hole 241 through which the brake shaft 212 may pass. Furthermore, the brake housing 240 may include an inner case 242 having a threshold 242a at its one end. The brake housing 240 may also include an outer case 244 having a threshold 244a at its one end such that the threshold 242a and threshold 244a are at opposite ends of each other. The thresholds 242a and 244a may be hooked by the thresholds 232 of the second magnetic generator 230 so that the second magnetic generator 230 may move horizontally in the brake housing 240, without separating there from.

The brake housing 240 may be fixed to the brake unit bracket 260 by a plurality of fixing screws 246. The brake unit bracket 260 may be fixed to the drive unit bracket 131 by a plurality of fixing screws 262a and 262b (see FIG. 2). In addition, the brake unit bracket 260 may also include a through-hole 262. The through-hole 262 may be configured so that the brake shaft 212 may pass through it.

The brake housing 240 may also include a plurality of resilient members 250. Specifically, the resilient members 250 may be fixedly installed in the brake housing 240 to resiliently support the second magnetic generator 230 towards the first magnetic generator 220. In an exemplary embodiment, the resilient members 250 may include compression coil springs.

The brake unit 200 may be controlled by the main controller 170. Specifically, as shown in FIG. 2, the brake unit 200 may connect to the main controller 170 through a cable 270. Furthermore, the brake unit 200 may receive signals from the main controller 170 to control the rotation of the lead screw 120. For example, the brake unit 200 may receive a non-brake signal from the main controller 170 to enable the rotation of the lead screw 120. Specifically, when the non-brake signal is applied to the brake unit 200, a current may be supplied to the second magnetic generator 230 to generate a repulsion force between the first and second magnetic generators 220 and 230, thereby keeping the two generators 220 and 230 in non-contact with each other. FIG. 4A illustrates the non-contact state, i.e., a non-brake state.

On the other hand, when a brake signal is applied to the brake unit 200 to stop the rotation of the lead screw 120, the current is supplied in a reverse direction to generate an attraction force between the first and second magnetic generators 220 and 230, thereby bringing and keeping the generators 220 and 230 in contact with each other. FIG. 4B illustrates the contact state, i.e., a brake state. Therefore, a frictional force may act on an interface between the first and second magnetic generators 220 and 230 to stop the rotation of the lead screw 120 connected to brake gear 210. In an exemplary embodiment, the resilient members 250 may support the second magnetic generator 230 towards the first magnetic generator 220 to increase the frictional force acting on the interface, thereby increasing the braking force of the brake unit 200.

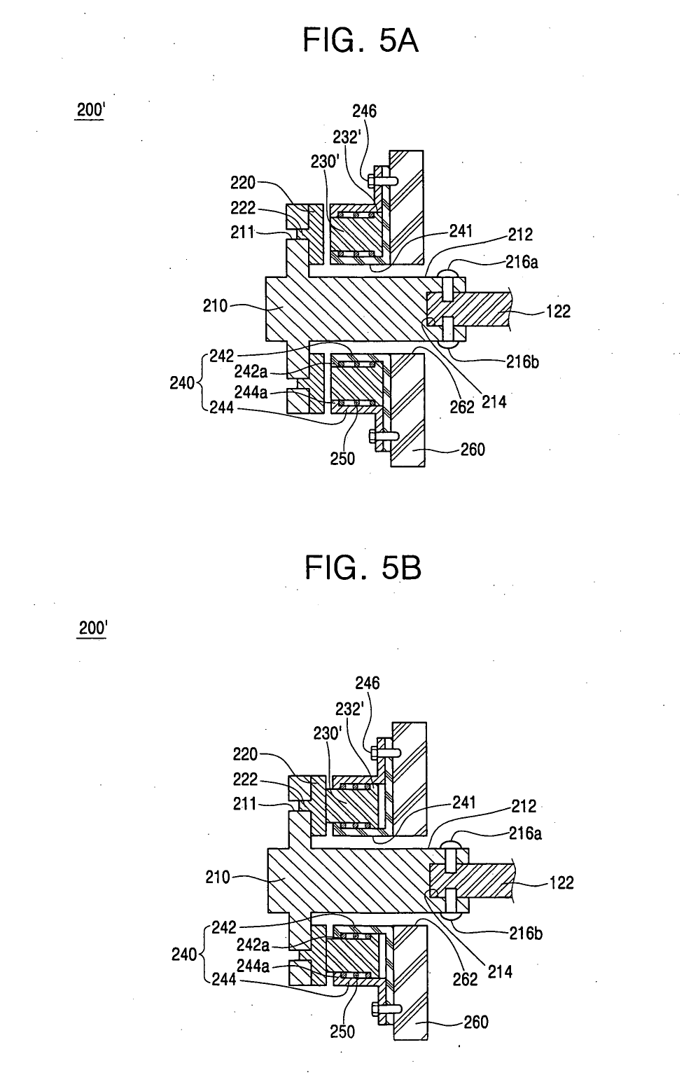

Hereinafter, an alternative embodiment of a brake unit 200′ for stopping the rotation of lead screw 120 will be described with reference to the accompanying drawings. FIGS. 5A and 5B are cross-sectional views of a brake unit 200′ included in a faraday cup assembly in accordance with an alternative embodiment of the present invention. Specifically, FIG. 5A is a cross-sectional view in a non-brake state, and FIG. 5B is a cross-sectional view in a brake state.

Referring to FIGS. 5A and 5B, the brake unit 200′ has the same components as the brake unit 200, except that a second magnetic generator 230′ is installed in the brake housing 240 and two resilient members 250 for resiliently supporting second magnetic generator 230′ are disposed in the brake unit 200′. These distinctive characteristics of the brake unit 200′ are described below, while a description of the same components as found in the brake unit 200 is omitted to avoid redundancy.

The second magnetic generator 230′ of the brake unit 200′ also has a ring shape like the second magnetic generator 230 and includes the thresholds 232′ formed at inner and outer edges of its one end. However, the second magnetic generator 230′ has a thickness which larger than that of the second magnetic generator 230 due to the disposition of the resilient members 250. Specifically, each of the resilient members 250 of the brake unit 200′ is provided with one end supported on the thresholds 232′ of the second magnetic generator 230 and the other end supported on thresholds 242a and 244a of the brake housing 240. This arrangement of the resilient members 250 may separate the second magnetic generator 230′ from the first magnetic generator 220.

As shown in FIG. 5B, the second magnetic generator 230′ is in non-contact with the first magnetic generator 220 because of the resilient members 250. Therefore, the brake unit 200′ only requires a brake signal when it is necessary to stop the rotation of lead screw 120. There is no requirement of a non-brake signal to enable the rotation of the lead screw 120. This portion of the operation of the brake unit 200′ is different than that of the brake unit 200 where a non-brake signal is required to enable the rotation of lead screw 120. In an exemplary embodiment, when the brake signal is applied to the brake unit 200′, a current may be supplied to the second magnetic generator 230′ to generate an attraction force between the first and second magnetic generators 220 and 230′, thereby causing the generators 220 and 230′ to contact each other. FIG. 5B illustrates the contact state, i.e., the brake state. Therefore, frictional force acts on an interface between the first and second magnetic generators 220 and 230′ to stop the rotation of the lead screw 120 connected to the brake gear 210.

Referring back to FIGS. 2 and 3, faraday cup assembly 100 also includes a faraday cup position detection unit 300. The faraday cup position detection unit 300 may be configured to detect a position of the faraday cup 150. In an exemplary embodiment, this positional information may be transmitted to the main controller 170.

The faraday cup position detection unit 300 may include a wire mounting member 310, a sensor mounting member 320, and a sensor controller 340. The wire mounting member 310 may include a wire 312 disposed at its lower end, representing a position of the faraday cup 150. The wire 312 may be mounted on the wire mounting member 310 with a fixing screw 314. Furthermore, the wire mounting member 310 may be fixed to the shaft fixing bracket 144 of the carrier 140 with a fixing screw 316. This arrangement may cause the wire mounting member 310 to move together with the carrier 140.

The faraday cup assembly 100 may also include a sensor mounting member 320. The sensor mounting member 320 may include a slit 322 which provides an opening for the wire 312 to pass through; The sensor mounting member 320 may be fixed to the frame 110. Specifically, a fixing screw 324a and a washer 324b may be used to fix the sensor mounting member 320 to the frame 110.

The faraday cup assembly 100 may also include wire detection sensors 332 and 336. The wire detection sensors 332 and 336 may be used for sensing the wire 312 which is installed at the upper and lower parts of the slit 322. The wire detection sensors 332 and 336 may include a first sensor 332 and a plurality of second sensors 336. The sensor 332 may be configured to sense whether the faraday cup 150 is positioned away from the wafer W (not shown) by a predetermined distance (hereinafter referred to as “a reference position”) in order to measure a dosage of an ion beam injected into the wafer during the ion implantation process. The second sensors 336 may be configured to sense whether the faraday cup 150 is moving (hereinafter referred to as “a variable position”) in order to measure the uniformity of the ion beam before the ion implantation process begins.

In an exemplary embodiment, the first sensor 332 may be an infrared sensor including a light emitting part 332a and a light receiving part 332b. The light emitting part 332a and light receiving part 332b may be configured to determine whether the faraday cup 150 is at a reference position based on the movement of the wire 312. For example, when the wire 312 moves together with the faraday cup 150 and blocks light emitted from the light emitting part 332a so that no light is transmitted to the light receiving part 332b, the first sensor 332 may sense the existence of the wire 312 to indirectly confirm a position of faraday cup 150. Similarly, each of the second sensors 336 may be an infrared sensor including a light emitting part 336a and a light receiving part 336b corresponding to light emitting part 336a.

The faraday cup assembly 100 may also include a sensor controller 340. The sensor controller 340 may be mounted on the frame 110 with a fixing screw 342. In an exemplary embodiment, sensor controller 340 may be configured to supply power to the wire detection sensors 332 and 336. In addition, or alternatively, the sensor controller 340 may be configured to input/output detection signals from the wire detection sensors 332 and 336.

The sensor controller 340 may be operatively connected to the wire detection sensors 332 and 336. In an exemplary embodiment, the sensor controller 340 may connect to the wire detection sensors 332 and 336 through a sensor cable 334. The sensor cable 334 may include cables 334a and 334b connected to the light emitting part 332a and light receiving part 332b of the first sensor 332, respectively. While only the sensor cable 334 for connecting sensor controller 340 and first sensor 332 is shown in the drawings, one skilled in the art will appreciate that a separate sensor cable (not shown) also electrically connects the sensor controller 340 and the second sensors 336. In addition, the sensor controller 340 may also connect to the main controller 170 through the cable 344.

The faraday cup assembly 100 may also include a cover 350. The cover 350 may be used to protect the cable 334a. In addition, the cover 350 may also protect cables (not shown) that connect the sensor controller 340 and the light emitting parts 336a of the second sensors 336. The cover 350 may be mounted on the sensor mounting member 320 with a fixing screw 352.

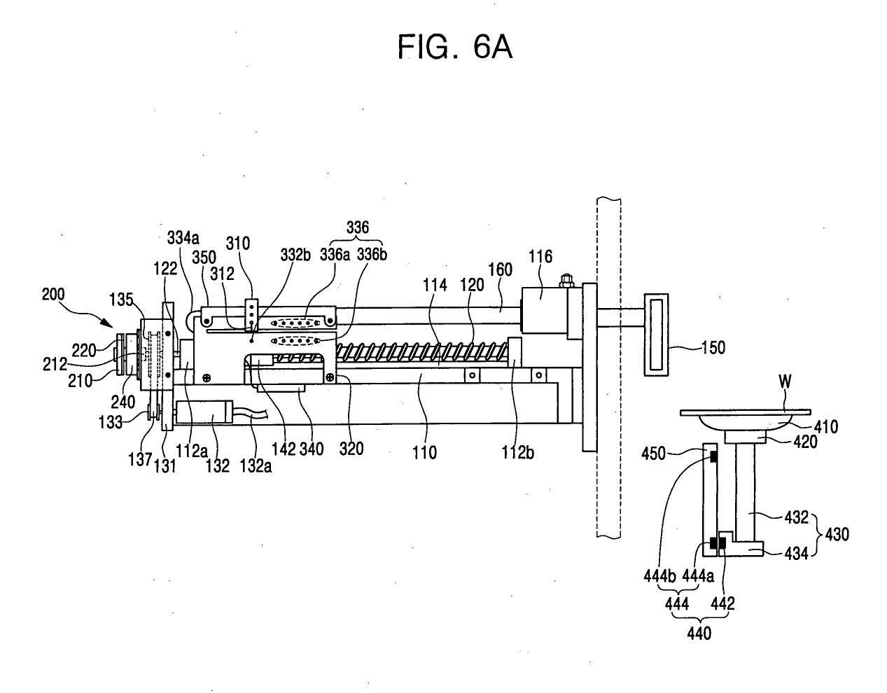

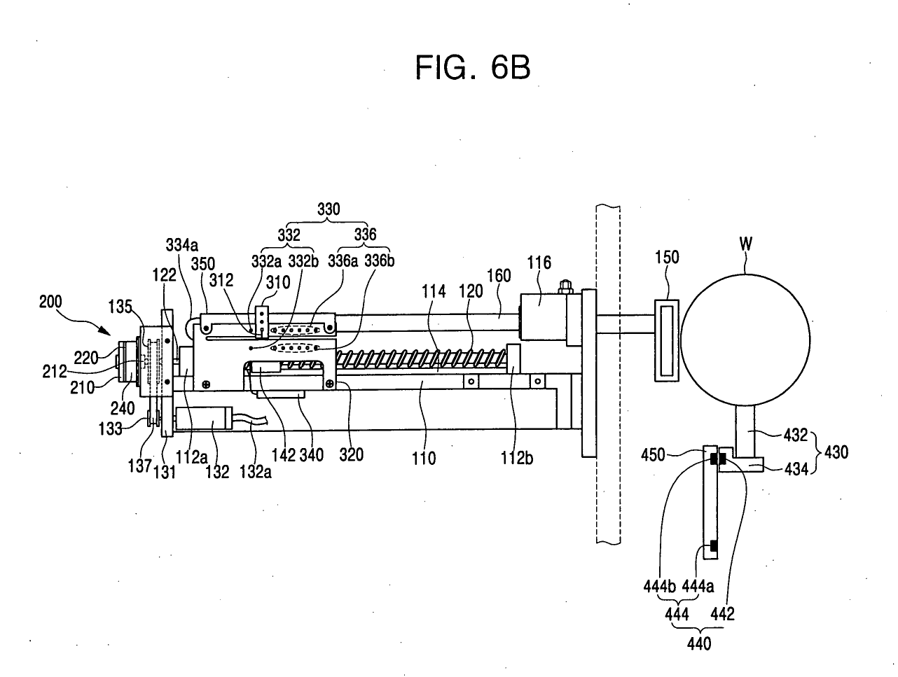

In an exemplary embodiment, the faraday cup assembly 100 further includes a wafer position detection unit 440. The wafer position detection unit 440 may be configured to detect a position of a wafer W in the vacuum chamber. This positional information may be transmitted to the main controller 170. Hereinafter, the wafer position detection unit 440 will be described with reference to the accompanying drawings. FIGS. 6A and 6B are side views of the faraday cup assembly 100 in accordance with an embodiment of the present invention when the wafer W is in a standby position and a process position, respectively.

Referring to FIGS. 6A and 6B, the wafer position detection unit 440 includes a positioning part 442, a drive part 430, a platen 410, a positioning part detection sensor 444, a drive shaft 432, and a support member 434.

In an exemplary embodiment, the positioning part 442, may be mounted on the drive part 430. The drive part 430 may be configured to raise and lower the platen 410. The platen 410 may be configured to support the wafer W. The drive part 430 may also include a drive shaft 432. The drive shaft 432 may be configured to raise and lower the platen 410. In addition, the drive part 430 may also include the support member 434 for supporting the drive shaft 432. The positioning part 442 may be mounted on the support member 434. The wafer position detection unit 440 may also include the positioning part detection sensor 444. The position part detection sensor 444 may be configured to sense the positioning part 442 to detect a position of the wafer W. The positioning part detection sensor 444 may be configured to mount onto the support member 434. Specifically, a plate 450 may be used to mount the positioning part detection sensor 444 onto support member 434.

In an exemplary embodiment, the wafer position detection unit 440 may also be configured to rotate the wafer W during the ion implantation process. Specifically, a tilt part 420 may be used for rotating the platen 410 to align the wafer W to a direction orthogonal to a progress direction of the ion beam.

In an exemplary embodiment, the positioning part 442 may be formed of a magnetic material. This may help determine the location of the positioning part 442. For example, as shown in FIG. 6A, the positioning part detection sensor 444 may include a first magnetic sensor 444a for sensing the magnetic material of positioning part 442 to detect whether the wafer W is in the standby position. Similarly, the positioning part detection sensor 444 may also include a second magnetic sensor 444b for sensing the magnetic material of the positioning part 442 to detect whether the wafer W is in the process position (as shown in FIG. 6B).

In an alternative exemplary embodiment of the wafer position detection unit 440, the positioning part 442 may be formed of a light emitting sensor. In this instance, as shown in FIG. 6A, the positioning part detection sensor 444 may include a first light receiving sensor 444a for receiving light emitted from the light emitting sensor of the positioning part 442 to detect whether the wafer W is in the standby position. Similarly, the positioning part detection sensor 444 may also include a second light receiving sensor 444b for receiving the light emitted from the light emitting sensor of the positioning part 442 to detect whether the wafer W is in the process position (as shown in FIG. 6B). In addition, the position part 442 may be formed of any other sensory device such as, for example, a hydraulic sensor, electric sensor, resistance sensor, etc.

Hereinafter, operation of the faraday cup assembly 100 in accordance with an embodiment of the present invention will be described with reference to FIGS. 2 to 6B.

First, as shown in FIG. 3, the faraday cup assembly 100 is installed at a sidewall 10 of a vacuum chamber. Then, as shown in FIG. 6A, when the wafer W is disposed in the standby position on the platen 410, the drive motor 132 rotates the lead screw 120 to move the faraday cup adjusting shaft 160, thereby positioning the faraday cup 150 in the reference position. At this time, the wire 312 that is moved together with the faraday cup adjusting shaft 160 is disposed between the light emitting part 332a and light receiving part 332b of the first sensor 332. This movement of the wire 312 blocks light emitted from light emitting part 332a, and thereby the light receiving part 332b receives no light from light emitting part 332a. As described above, the wafer position detection unit 440 detects whether the wafer W is in the standby position or process position. While the wafer W is waiting in the standby position, a non-brake signal is applied to the brake unit 200 to make the faraday cup 150 movable.

In addition, before performing the ion implantation process, the faraday cup 150 is repeatedly moved back and forth horizontally in order to measure the uniformity of an ion beam by repeating forward and reverse rotation of the drive motor 132. The operation of the drive motor 132 is controlled based on the output of the faraday cup detection unit 300, i.e., based on the location of the faraday cup 150. After the uniformity of the ion beam is measured, the faraday cup 150 is returned to its reference position.

In order to begin the ion implantation process on the wafer W, the wafer W needs to be in the process position as shown in FIG. 6B. In an exemplary embodiment, the drive part 430 and the tilt part 420 may be configured to bring the wafer W into the process position. Specifically, while the drive part 430 is raised up to a predetermined height by a drive means (not shown), the tilt part 420 rotates to dispose the wafer W in a direction vertical to the ion beam. When the wafer W is disposed in the process position, the ion implantation process is performed. At this time, the faraday cup 150 stays in the reference position to measure a dosage of the ion beam injected into the wafer W. When the wafer position detection unit 440 detects that the wafer W is in the process position, and when the faraday cup detection unit 330 detects that the faraday cup 150 is in the reference position, a non-brake signal is applied to the brake unit 200.

However, when an incorrect control signal is applied to the drive motor 132 or if power supplied to the drive motor 132 is interrupted while the wafer W is disposed in the process position to perform the ion implantation process, the faraday cup assembly 100 may lose positional controllability of the faraday cup 150. In this case, due to a high vacuum in the vacuum chamber, the faraday cup 150 may move towards the wafer W and collide with the wafer W or the platen 410. FIG. 6B illustrates a situation just before the faraday cup 150 collides with the wafer W. Furthermore, in this situation, the wire 312 of the faraday cup position detection unit 300 may be undetectable by the first sensor 332.

However, the faraday cup assembly 100 in accordance with the present invention may prevent the aforementioned problems. That is, when the wafer W exists in the process position and the faraday cup position detection unit 300 detects that the faraday cup 150 is out of the reference position, the main controller 170 may apply a brake signal to the brake unit 200 or 200′. This brake signal may forcedly stop the rotation of lead screw 120 and the resulting movement of the faraday cup 150. This stoppage of the rotation of the lead screw 120 may prevent the faraday cup 150 from colliding with the wafer W or platen 410, thereby avoiding any damage due to the potential collision.

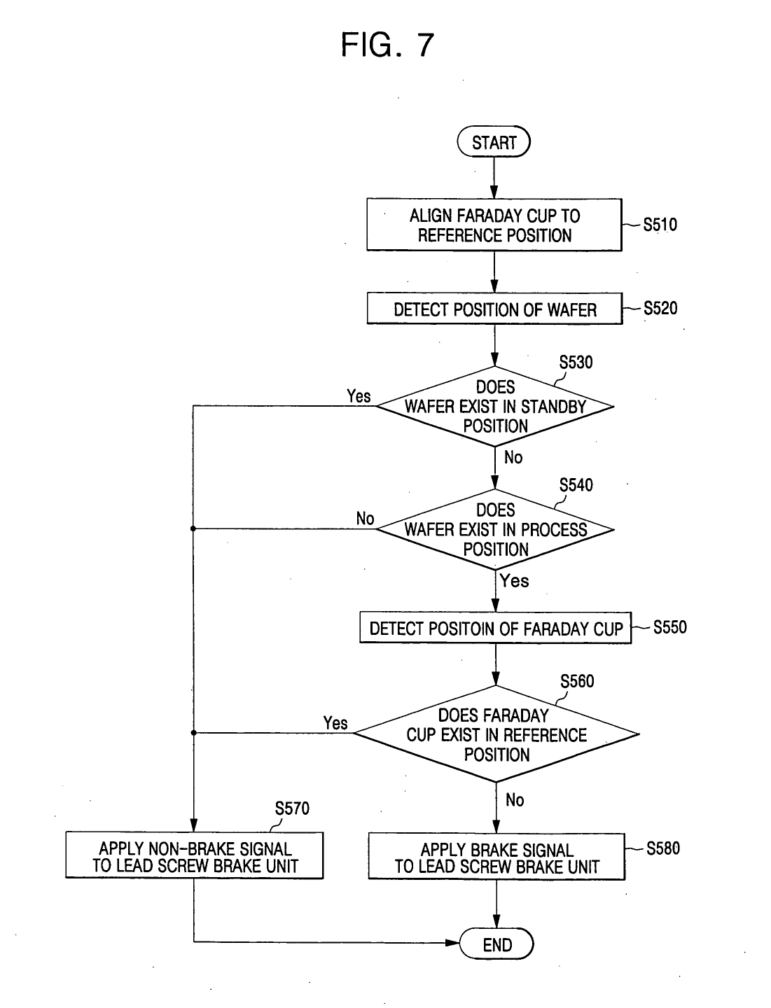

Hereinafter, an alternative method of controlling a faraday cup assembly in accordance with the present invention will be described with reference to FIG. 7. Specifically, FIG. 7 is a flowchart illustrating the steps of an exemplary disclosed faraday cup assembly control method.

Referring to FIGS. 6A and 7, at step 510, the faraday cup 150 may be aligned to a reference position such that it is spaced apart from the wafer W that is to be disposed in a process position for ion implantation. At step 520, the, position of the wafer W may be detected by the wafer position detection unit 440.

At step 530, the position detection unit 440 may detect whether the wafer W exists in a standby position corresponding to a process position by a predetermined distance. If the wafer W exists in the standby position, then, at step 570, a non-brake signal may be applied to the brake unit 200, regardless of the disposition of the faraday cup 150.

However, if the wafer W is out of the standby position, then, at step 540, the position detection unit 440 may detect whether the wafer W exists in the process position. If the wafer W is not in the process position, then, at step 570, a non-brake signal may be applied to the brake unit 200, regardless of disposition of the faraday cup 150.

On the other hand, if the wafer W is in the process position, then, at step 550, the faraday cup position detection unit 300 may detect the position of the faraday cup 150. Specifically, at step 560, the faraday cup position detection unit 300 may detect whether the faraday cup 150 exists in the reference position. If the faraday cup 150 is in the reference position, then, at step 570, a non-brake signal may be applied to the brake unit 200.

However, if the faraday cup 150 is out of the reference position, then, at step 580, a brake signal may be applied to the brake unit 200 or 200′ to forcedly stop the rotation of the lead screw 120 and the movement of the faraday cup 150.

As described above, an incorrect control signal may be applied to a drive motor for moving a faraday cup when a wafer is disposed in a process position to perform an ion implantation process. Alternatively, the power supplied to the drive motor may be interrupted when the wafer is in the process position. Under such conditions, the faraday cup assembly may be unable to control the position of the faraday cup. The disclosed faraday cup assembly control system may be used to control the position of the faraday cup. Specifically, the disclosed system may stop the movement of the faraday cup by detecting a position of the faraday cup using a faraday cup position detection unit and forcedly stopping the rotation of a lead screw for moving the faraday cup using a brake unit when the faraday cup is out of a reference position. As a result, it may be possible to prevent the faraday cup from colliding with the wafer or a platen during the ion implantation process.

While the present invention has been particularly shown and described with reference to exemplary embodiments thereof, it will be understood by those of ordinary skill in the art that various changes in form and details may be made therein without departing from the spirit and scope of the present invention as defined by the following claims.

Further, throughout this disclosure and the claims that follow, it will be understood that when an element is referred to as being “on,” “connected to,” “attached to,” “engaged with,” “coupled to,”, etc., another element, it can be directly on, attached to, engaged with, connected to or coupled to the other element, or intervening elements may be present so long as the operative relationship (if any) between the referenced elements is maintained.

What is claimed is:

1. A faraday cup assembly comprising:
a frame attached to a sidewall of a vacuum chamber;
a lead screw rotatably attached to the frame;
a drive unit which rotates the lead screw;
a carrier engaged with the lead screw and horizontally movable with a rotation of the lead screw;
a faraday cup located in the vacuum chamber;
a shaft extending through the frame and including a first end engaged with the faraday cup and a second end attached to the carrier;
a brake unit which selectively stops the rotation of the lead screw; and
a main controller which controls at least one of the drive unit and the brake unit.

2. The faraday cup assembly according to claim 1, wherein the drive unit comprises:
a drive unit bracket attached to a side of the frame;
a drive motor mounted on the drive unit bracket;
a drive pulley attached to the drive motor;
a driven pulley attached to the lead screw; and
a belt which engages the drive pulley and the driven pulley.

3. The faraday cup assembly according to claim 2, wherein the brake unit comprises:
a brake gear which includes a first magnetic generator and is attached to the lead screw;
a brake unit bracket attached to the drive unit bracket;
a second magnetic generator located adjacent to the first magnetic generator and which generates an attraction or repulsion force which causes the second magnetic generator to be in contact or non-contact state with the first magnetic generator; and
a brake housing which receives the second magnetic generator and is attached to the brake unit bracket.

4. The faraday cup assembly according to claim 3, further comprising a resilient member located in the brake housing which resiliently supports the second magnetic generator towards the first magnetic generator.

5. The faraday cup assembly according to claim 3, further comprising a resilient member located in the brake housing which resiliently supports the second magnetic generator in a direction spaced from the first magnetic generator.

6. The faraday cup assembly according to claim 3, wherein the first magnetic generator is a permanent magnet and the second magnetic generator is an electromagnet.

7. The faraday cup assembly according to claim 3, wherein, when a non-brake signal is applied from the main controller to the brake unit, the repulsion force is generated between the first and second magnetic generators to cause the second magnetic generator to be in the non-contact state with the first magnetic generator.

8. The faraday cup assembly according to claim 3, wherein, when a brake signal is applied from the main controller to the brake unit, the attraction force is generated between the first and second magnetic generators to cause the second magnetic generator to be in the contact state with the first magnetic generator.

9. The faraday cup assembly according to claim 3, further comprising a faraday cup position detection unit which detects a position of the faraday cup.

10. The faraday cup assembly according to claim 9, wherein the faraday cup position detection unit comprises:
a wire mounting member attached to the carrier and including a wire which indicates the position of the faraday cup;
a wire detection sensor attached to the frame which detects the wire;
a sensor mounting member having an opening through which the wire moves; and
a sensor controller which supplies power to the wire detection sensor and inputs and outputs a detection signal from the wire detection sensor.

11. The faraday cup assembly according to claim 10, wherein the wire detection sensor comprises:
a first sensor which detects whether the faraday cup is in a reference position during an ion implantation process; and
a plurality of second sensors which detect whether the faraday cup is moving before performing the ion implantation process.

12. The faraday cup assembly according to claim 11, wherein each of the first and second sensors is an infrared sensor including a light emitting part and a light receiving part.

13. The faraday cup assembly according to claim 11, further comprising a wafer position detection unit which detects a position of a wafer in the vacuum chamber.

14. The faraday cup assembly according to claim 13, wherein the wafer position detection unit comprises:
a positioning part attached to a drive part which raises and lowers a platen that supports the wafer; and
a positioning part detection sensor which senses the positioning part to detect the position of the wafer.

15. The faraday cup assembly according to claim 14, wherein the positioning part is formed of a magnetic material, and the positioning part detection sensor comprises:
a first magnetic sensor which senses the magnetic material to detect whether the wafer is in a standby position; and
a second magnetic sensor which senses the magnetic material to detect whether the wafer is in a process position.

16. The faraday cup assembly according to claim 14, wherein the positioning part includes a light emitting sensor, and the positioning part detection sensor comprises:
a first light receiving sensor which receives light emitted from the light emitting sensor to detect whether the wafer is in a standby position; and
a second light receiving sensor which receives light emitted from the light emitting sensor to detect whether the wafer is in a process position.

17. A method of controlling a faraday cup, the method comprising:
(a) rotating a lead screw engaged with a faraday cup to align the faraday cup to a reference position spaced apart from a wafer to be disposed in a process position where an ion implantation process is performed;
(b) detecting a position of the faraday cup using a faraday cup position detection unit; and
(c) selectively braking the lead screw by applying a brake or non-brake signal to a lead screw brake unit based on the detected position of the faraday cup.

18. The method according to claim 17, comprising, upon detection that the faraday cup is out of the reference position, applying the brake signal to the lead screw brake unit.

19. The method according to claim 17, further comprising detecting a position of the wafer using a wafer position detection unit.

20. The method according to claim 19, comprising, when it is detected that the wafer exists in a standby position located under the process position by a predetermined distance, the non-brake signal is applied to the lead screw brake unit regardless of the position of the faraday cup.

21. The method according to claim 19, comprising, upon detection that the wafer exists in the process position and the faraday cup is out of the reference position, applying the brake signal to the lead screw brake unit to brake the lead screw.
